(19) United States
(12) Patent Application Publication
(10) Pub. No.: US 2023/0043774 A1
(43) Pub. Date: Feb. 9, 2023

(54) GAS SEPARATION MEMBRANE, GAS SEPARATION MEMBRANE ELEMENT AND GAS PRODUCTION METHOD

(71) Applicant: Toray Industries, Inc., Tokyo (JP)

(72) Inventors: Takahiro Tokuyama, Otsu-shi, Shiga (JP); Rina Iizuka, Otsu-shi, Shiga (JP); Yoko Hasegawa, Otsu-shi, Shiga (JP); Hiroho Hirozawa, Otsu-shi, Shiga (JP); Hiroyuki Yamada, Otsu-shi, Shiga (JP)

(73) Assignee: Toray Industries, Inc., Tokyo (JP)

(21) Appl. No.: 17/786,155

(22) PCT Filed: Dec. 22, 2020
(86) PCT No.: PCT/JP2020/047875

§ 371 Date: Jun. 16, 2022

(30) Foreign Application Priority Data
Dec. 23, 2019 (JP) 2019-231576

(51) Int. Cl. B01D 53/22; B01D 63/10; B01D 65/10; B01D 69/02; B01D 69/10; B01D 69/12; B01D 71/56

(52) U.S. Cl. CPC B01D 53/228; B01D 63/10; B01D 65/10; B01D 69/02; B01D 69/10; B01D 69/1214; B01D 71/56; B01D 69/1216; B01D 69/1251; B01D 2256/16; B01D 2256/18; B01D 2257/504; B01D 2257/104; B01D 2257/102; B01D 2257/80; B01D 2325/06; B01D 2325/20; B01D 2325/24; B01D 2323/30

(57) ABSTRACT

The present invention aims to improve the separation selectivity for light gases such as hydrogen and helium. The gas separation membrane according to the present invention includes a porous support layer and a separation functional layer containing a cross-linked polyamide and laid on the porous support layer, wherein: the separation functional layer has a protuberance structure containing a plurality of protrusions and recesses; randomly selected 20 of the protrusions on the surface of the separation functional layer indented under a load of 3 nN and observed in pure water at 25° C. by atomic force microscopy give an average deformation of 5.0 nm or more and 10.0 nm or less; and they give a standard deviation of the deformation of 5.0 nm or less.

### CROSS REFERENCE TO RELATED APPLICATIONS

This application is the U.S. National Phase application of PCT/JP2020/047875, filed Dec. 22, 2020, which claims priority to Japanese Patent Application No. 2019-231576, filed Dec. 23, 2019, the disclosures of these applications being incorporated herein by reference in their entireties for all purposes.

### FIELD OF THE INVENTION

The present invention relates to a gas separation membrane and a gas separation membrane element that include polyamide composite membranes to separate light gases such as helium and hydrogen from carbon dioxide, oxygen, or nitrogen, and also relates to a gas production method using them.

### BACKGROUND OF THE INVENTION

In recent years, attention has been focused on hydrogen as a clean energy source. Hydrogen is generally obtained by gasifying fossil fuels such as natural gas and coal to produce a mixed gas containing hydrogen and carbon dioxide as main components and then removing carbon dioxide therefrom. In another method, it is obtained by decomposing water using electricity or a catalyst to produce a mixed gas containing hydrogen, oxygen, and water vapor and then extracting only hydrogen therefrom. Hydrogen has been applied to the Haber-Bosch process, which is designed to synthesize ammonia. This method synthesizes ammonia by reacting hydrogen and nitrogen at a high temperature under a high pressure, but a process for separating and recovering unreacted hydrogen and nitrogen is necessary in the production plant.

As a method for concentrating a mixed gas to separating a specific gas component at low cost, attention has been focused on the membrane separation technique, which is intended for selective permeation of a target gas by means of differences in permeability of the material to different gases. Non-patent document 1 discloses a technique designed for an interfacial polycondensation reaction to form a crosslinked aromatic polyamide in the form of an extremely thin functional layer that has a high gas permeability.

### NON-PATENT DOCUMENTS

Non-patent document: Albo, three others, Journal of Membrane Science, 449, 2014, pp. 109-118

### SUMMARY OF THE INVENTION

The techniques described above, however, have the problem of low separation efficiency because of low separation selectivity between light gases such as hydrogen and helium and other gases such as carbon dioxide, oxygen, nitrogen, and methane.

The present invention, which was made in view of the above-mentioned conventional technologies, is intended to provide a gas separation membrane having high separation selectivity between light gases such as hydrogen and helium and other gases such as carbon dioxide, oxygen, nitrogen, and methane.

In order to solve the above problems, the gas separation membrane according to the present invention includes a support membrane having a base substrate and a porous support layer laid on the base substrate, and a separation functional layer laid on the porous support layer, wherein: the separation functional layer is a thin layer having a protuberance structure containing a plurality of protrusions and recesses; 20 of the protrusions give an average deformation of 5.0 nm or more and 10.0 nm or less in a 3 nN indentation test performed in pure water at 25° C.; and the standard deviation of the deformation is 5.0 nm or less.

The present invention also provides a gas separation element that includes the gas separation membrane and a gas production method that uses the gas separation membrane.

The present invention can provide a gas separation membrane and a gas separation membrane element that have high separation selectivity for light gases such as hydrogen and helium and also provide a gas production method using them.

### BRIEF DESCRIPTION OF THE DRAWINGS

FIG. 1 is a cross-sectional view of the gas separation membrane.

FIG. 2 is a schematic diagram illustrating the method for measuring the height of the protrusions in the separation functional layer.

FIG. 3 is a schematic diagram illustrating the method for measuring the deformation of the protrusions in the separation functional layer.

FIG. 4 shows a partially developed perspective diagram illustrating an embodiment of the gas separation membrane element according to the present invention.

FIG. 5 is a schematic diagram illustrating the set-up that was used for measuring the gas permeabilities of separation membranes.

### DETAILED DESCRIPTION OF EMBODIMENTS OF THE INVENTION

### 1. Gas Separation Membrane

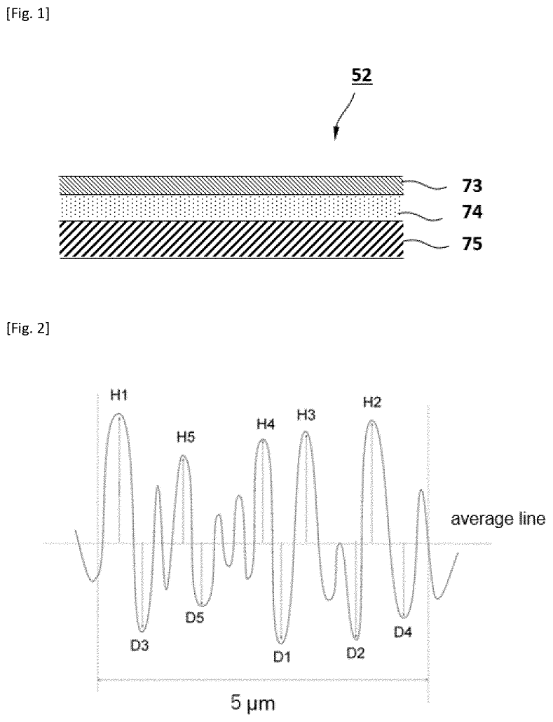

The gas separation membrane (hereinafter occasionally referred to simply as separation membrane) 52 according to the present embodiment consists mainly of a base substrate 75, a porous support layer 74 laid on the base substrate, and a separation functional layer 73 laid on the porous support layer as illustrated in FIG. 1.

### (1-1) Base Substrate

The base substrate should at least be permeable to hydrogen and helium. The base substrate should not necessarily have selective gas permeability and is only required to be able to form a support membrane in combination with the porous support layer to serve for supporting the separation functional layer so as to maintain the strength of the entire separation membrane.

There are no particular limitations on the components of the base substrate, and examples thereof include, for example, polyester based polymers, polyamide based polymers, polyolefin based polymers, polysulfide based polymers, and copolymers thereof. Polyester based polymers are particularly preferred because they have high mechanical and thermal stability.

It is preferable for the base substrate to be in the form of fabric. Such a fabric is preferably in the form of long fiber nonwoven fabric, short fiber nonwoven fabric, or woven/knitted fabric. Here, a long fiber nonwoven fabric means a nonwoven fabric having an average fiber length of 300 mm or more and an average fiber diameter of 3 to 30 μm.

It is preferable for the base substrate to have an air permeability of 0.5 cc/cm²/sec or more and 5.0 cc/cm²/sec or less. In the case of a base substrate having an air permeability in the above range, as a support membrane is produced by forming a porous support layer on the base substrate, a solution of a polymer used as a component of the porous support layer infiltrates into the base substrate to create a support membrane in which the porous support layer located on the base substrate is strongly adhered to the base substrate, making it possible to obtain a support membrane with high physical stability.

It is preferable for the base substrate to have a thickness in the range of 10 to 200 μm, more preferably in the range of 30 to 120 μm. For the present Description, the thickness of a membrane specimen is determined by taking thickness measurements from 20 thickness-directional cross sections (cross sections perpendicular to the direction of the membrane surface) separated at regular intervals of 20 μm and averaging the measurements, unless otherwise specified.

### (1-2) Porous Support Layer

The porous support layer should at least be permeable to hydrogen or helium. The porous support layer should not necessarily have selective gas permeability, and is only required to be able to form a support membrane in combination with the base substrate to serve for supporting the separation functional membrane so as to maintain the strength of the entire separation membrane.

There are no particular limitations on the size and distribution of the pores inside the porous support layer. The pore size, for example, may be constant over the entire porous support layer or may gradually increase from the surface in contact with the separation functional layer toward the other surface of the porous support layer.

In addition, the pore size of the porous support layer is preferably 0.1 nm or more and 100 nm or less at the surface in contact with the separation functional layer.

There are no particular limitations on the components of the porous support layer, and for example, it may contain at least one polymer selected from the group consisting of polysulfone, polyethersulfone, polyamide, polyesters, cellulose based polymers, vinyl polymers, polyphenylene sulfide, polyphenylene sulfide sulfone, polyphenylene sulfone, polyphenylene oxide, and other homopolymers and copolymers thereof.

Here, examples of the cellulose based polymers include cellulose acetate and cellulose nitrate, and examples of the vinyl polymers include polyethylene, polypropylene, polyvinyl chloride, and polyacrylonitrile.

It is preferable for the porous support layer to contain polysulfone, polyethersulfone, polyamide, polyester, cellulose acetate, cellulose nitrate, polyvinyl chloride, polyacrylonitrile, polyphenylene sulfide, polyphenylene sulfide sulfone, other homopolymers, or copolymers thereof. Of these, the use of a homopolymer of either polyethersulfone or polyamide or a copolymer thereof is particularly preferable because they have high glass transition temperatures and high thermal stability accordingly. In addition, polyethersulfone and polyamide are suitable for easy membrane production. Furthermore, the use of polyethersulfone or polyamide contributes to improvement in the adhesiveness between the separation functional layer and the support membrane because due to their primary structures, they have high chemical affinity (electrostatic interaction, hydrogen bonding, π-π interaction) for the cross-linked polyamide contained in the separation functional layer. The improvement in the adhesiveness between the separation functional layer and the support membrane contributes to the suppression of pinhole formation, leading to high selectivity for light gas separation.

The thicknesses of the base substrate and the porous support layer can affect the strength of the gas separation membrane and the packing density of an element produced therefrom. To ensure a sufficient mechanical strength and packing density, the total thickness of the base substrate and the porous support layer is preferably 30 μm or more and 300 μm or less and more preferably 100 μm or more and 220 μm or less. In addition, the thickness of the porous support layer is preferably 20 μm or more and 100 μm or less.

### (1-3) Separation Functional Layer

The separation functional layer is a thin layer. The thin layer has a protuberance structure that contains a plurality of protrusions and recesses. Furthermore, the thin layer contains, as primary component, a cross-linked polyamide produced through a polycondensation reaction of a polyamide-containing polyfunctional amine and a polyfunctional acid halide.

More specifically, in the separation functional layer, the cross-linked polyamide accounts for 50 wt % or more, preferably 70 wt % or more, more preferably 90 wt % or more, and the separation functional layer may be formed only of a cross-linked polyamide. If the cross-linked polyamide accounts for 50 wt % or more in the separation functional layer, it serves for the membrane to easily exhibit high performance. This cross-linked polyamide may be a fully aromatic polyamide, a fully aliphatic polyamide, or a combination of aromatic portions and aliphatic portions, but it is preferably a fully aromatic polyamide in order to realize high performance.

Here, the polyfunctional amine is specifically a polyfunctional aromatic amine or a polyfunctional aliphatic amine.

A polyfunctional aromatic amine means an aromatic amine that contains at least either two or more primary amino groups or two or more secondary amino group in one molecule with at least one of the amino groups contained being a primary amino group, and a polyfunctional aliphatic amine means an aliphatic amine that contains at least either two or more primary amino groups or two or more secondary amino group in one molecule with at least one of the amino groups contained being a primary amino group.

Examples of such a polyfunctional aromatic amine include a polyfunctional aromatic amine that contains two amino groups selected from o-phenylenediamine, m-phenylenediamine, p-phenylenediamine, o-xylylenediamine, m-xylylenediamine, p-xylylenediamine, o-diaminopyridine, m-diaminopyridine, and p-diaminopyridine bonded to an aromatic ring at the ortho, meta, or para positions, as well as 1,3,5-triaminobenzene, 1,2,4-triaminobenzene, 3,5-diaminobenzoic acid, 3-aminobenzyl amine, 4-aminobenzyl amine, 2,4-diaminothioanisole, 1,3-diaminothioanisole, 1,3-diamino-5-(dimethylphosphino)benzene, (3,5-diaminophenyl)dimethylphosphine oxide, (2,4-diaminophenyl)dimethylphosphine oxide, 1,3-diamino-5-(methylsulfonyl)benzene, 1,3-diamino-4-(methylsulfonyl)benzene, 1,3-diamino-5-nitrosobenzene, 1,3-diamino-4-nitrosobenzene, 1,3-diamino-5-(hydroxyamino)benzene, and 1, 3-diamino-4-(hydroxyamino)benzene.

On the other hand, examples of the polyfunctional aliphatic amine include ethylenediamine, 1,3-diaminopropane, 1,4-diaminobutane, 1,5-diaminopentane, piperazine, 2-methylpiperazine, 2,4-dimethylpiperazine, 2,5-dimethylpiperazine, and 2,6-dimethylpiperazine.

These polyfunctional amines may be used singly or two or more thereof may be used in combination.

Here, a polyfunctional acid halide specifically means either a polyfunctional aromatic acid halide or a polyfunctional aliphatic acid halide.

A polyfunctional acid halide is also referred to as a polyfunctional carboxylic acid derivative and is an acid halide having at least two carbonyl halide groups in one molecule. For example, typical trifunctional acid halides include trimesic acid chloride, and typical bifunctional acid halides include biphenyldicarboxylic acid dichloride, azobenzene dicarboxylic acid dichloride, terephthalic acid chloride, isophthalic acid chloride, naphthalene dicarboxylic acid dichloride, and oxalyl chloride.

Considering the reactivity with polyfunctional amines, the polyfunctional acid halide to be used is preferably a polyfunctional acid chloride. Considering the selective separation capability and heat resistance of membranes, it is preferably a polyfunctional acid chloride having 2 to 4 carbonyl chloride groups in one molecule.

In particular, the use of a trimesic acid chloride is more preferable from the viewpoint of availability and handleability. These polyfunctional acid halides may be used singly or two or more thereof may be used in combination.

In addition, a polycondensation reaction as referred to herein is specifically a interfacial polycondensation reaction.

Here, it is preferable that at least either the polyfunctional amine or the polyfunctional acid halide contain a tri- or more functional compound.

The separation functional layer has a protuberance structure that contains a plurality of recesses and protrusions. More specifically, the protuberance structure contains pairs of a recess and a protrusion arranged repeatedly.

For the separation functional layer of the present invention, protrusions mean those having heights equal to or larger than ⅕ of the ten point average roughness. The ten point average roughness is a value determined by the calculation procedure described below. First, a cross section perpendicular to the membrane surface is observed by electron microscopy. It is preferable for the observation to be perform at a magnification of 10,000 to 100,000. The resulting cross-sectional image includes a curve of the protuberance structure that represents the surface of the separation functional layer and contains pairs of a protrusion and a recess repeated continuously. From this curve, a roughness curve as defined in IS04287 (1997) is created (FIG. 2). From the cross-sectional image, a piece with a width of 5.0 μm in the direction of the average line for the roughness curve is cut out.

Here, the average line is a straight line as defined in IS04287 (1997) and it is drawn in the range of the measuring length in such a manner that total area of the regions surrounded by the average line and the roughness curve that are located above the average line and that below it are equal to each other.

In the 5.0 μm wide image cut out above, the heights of the protrusions and the depths of the recesses in the separation functional layer are measured. The height of a protrusion is the distance measured from the aforementioned average line to the top of the protrusion, whereas the depth of a recess is the distance measured from the average line to the lowest point of the recess. The five largest heights H1 to H5 are averaged and the five largest depths D1 to D5 are averaged, followed by adding up the absolute values of the resulting two averages. The sum thus calculated is the 10 point average roughness.

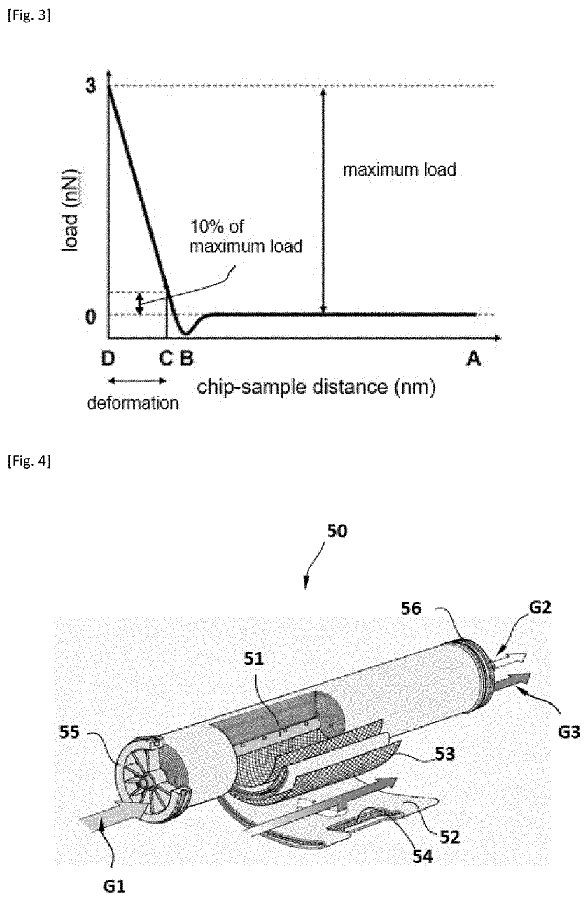

The deformation of a protrusion is determined from tapping-mode atomic force microscopy (AFM) in which while moving a chip toward the sample, the relation between the chip-sample distance and the load working on the cantilever is plotted to prepare a force curve. Specifically, as illustrated in FIG. 3, in a force curve in which the chip-sample distance (separation) and the load are plotted on the horizontal axis and the longitudinal axis, respectively, A is the point before moving the cantilever toward the sample, B the point where the load begins to increase as the cantilever is moved toward the sample, C the point where the load reaches 10% of the maximum load, and D the point where the load reaches a maximum, the distance between C and D is defined as the deformation.

Dimension FastScan, manufactured by Bruker AXS, can be used as the atomic force microscope. The use of an accessory attachment serves for observation in water. This observation is performed using a cantilever with a conical (pyramid type) probe. The cantilever should always be calibrated before use. First, the deflection sensitivity of the cantilever is measured using a substance having a sufficient hardness. As such a substance having a sufficient hardness, silicon wafer and sapphire can be used. Next, the spring constant of the cantilever is measured by the thermal tune method. Calibration can serve to improve the accuracy of measurement.

The deformation of the protrusions in a separation functional layer reflects the denseness of the pore structure in the separation functional layer. Specifically, the deformation increases as the pore structure of the separation functional layer decreases in denseness, whereas the deformation decreases as it increases in denseness. When the separation functional layer of the present invention is subjected to a test in which randomly selected 20 protrusions are indented under a maximum load of 3.0 nN in pure water at 25° C., the average deformation is 5.0 nm or more and 10.0 nm or less. The average herein means the arithmetical average.

If the average deformation is 10.0 nm or less, it means that the thin layer as the separation functional layer has a dense structure. If the thin layer has a dense structure, it means that the pores in the thin layer have small diameters, and therefore, the thin layer is permeable to light gases while preventing other gases from passing through. Thus, a membrane having an average deformation in the aforementioned range has high separation selectivity for light gases.

On the other hand, if the average deformation is 5.0 nm or more, the thin layer has a moderate flexibility, which leads to an increased physical structural stability against impacts caused by bending, folding, swinging, etc. and to an increased resistance to the generation of defective pinholes.

In addition, the standard deviation of the deformation is preferably 5.0 nm or less. If the standard deviation is in this range, it means that the thin layer has a uniform pore structure with a decreased number of coarse pores, and this ensures a high separation selectivity for light gases and a decreased variation in light gas separation selectivity of the membrane. The standard deviation is preferably 4.0 nm or less and particularly preferably 2.5 nm or less.

In addition, in order to realize a sufficient separation performance and gas permeability, the separation functional layer commonly has a thickness in the range of 0.01 to 1 μm, preferably in the range of 0.1 to 0.5 μm.

As described so far, the separation membrane according to the present invention has a dense structure. This means that the pores in the separation functional layer have small diameters, are uniform, and are highly free of bulky pores. Furthermore, the separation functional layer has a moderate plasticity and maintains strong adhesion to the support membrane. Due to these structural features, the separation membrane according to the present invention exhibits high separation selectivity for light gases, resists the generation of defective pinholes, and suffers little variation in separation selectivity for light gases in the membrane. In addition to these effects, it is characterized by low permeability to liquid water. Specifically, when subjected to a water permeability test in which an aqueous sodium chloride solution having a concentration of 3.5 wt %, adjusted to pH6.5, and maintained at a temperature of 25° C. is supplied under an operating pressure of 5.5 MPa, it is preferable for the membrane water permeation flux (m³/m²/day) to be 0.5 (m³/m²/day) or less.

For the separation membrane according to the present invention, a smaller membrane water permeation flux ensures a higher separation selectivity for light gases, a smaller variation in the light gas separation selectivity of the membrane, and slower generation of defective pinholes. The membrane water permeation flux is preferably 0.5 (m³/m²/day) or less, more preferably 0.3 (m³/m²/day) or less, still more preferably 0.2 (m³/m²/day) or less, and particularly preferably 0 (m³/m²/day). If the membrane water permeation flux is in this range, it means that the membrane has a favorable denseness for light gas separation. More specifically, the separation functional layer contains pores having small and uniform diameters and is highly free of bulky pores, and the separation functional layer has a moderate flexibility and maintains strong adhesion with the support membrane. Accordingly, this ensures a higher separation selectivity for light gases, a smaller variation in the light gas separation selectivity of the membrane, and slower generation of defective pinholes.

### 2. Production Method for Gas Separation Membrane

Described next is the production method for a gas separation membrane.

### (2-1) Formation of Support Membrane

A laminate of the base substrate and the porous support layer is referred to as support membrane. The method for forming a support membrane in the examples given below includes a step for preparing a polymer solution by dissolving the polymer adopted as a component of the porous support layer in a good solvent for the polymer, a step for coating a base substrate with the polymer solution, and a step for immersing the base substrate coated with the polymer solution in a coagulation bath to perform wet coagulation of the polymer contained in the polymer solution covering the base substrate. The coagulated polymer forms the porous support layer.

In the case where at least either polysulfone or polyethersulfone is used as the polymer, a polymer solution is prepared by dissolving it in N,N-dimethyl formamide (hereinafter referred to as DMF). Water is used favorably as the coagulating bath.

Polyamide, which is cited above as an example of the polymer component, can be produced through solution polymerization or interfacial polymerization using acid chloride and diamine as monomers. In the case of solution polymerization, useful solvents include aprotic organic polar solvents such as DMF, N-methylpyrrolidone (NMP), and dimethyl acetamide (DMAc). If a polyamide is produced using an acid chloride and a diamine as monomers, hydrogen chloride is generated as a by-product. When hydrogen chloride is neutralized, it is performed by using an inorganic neutralization agent such as calcium hydroxide, calcium carbonate, and lithium carbonate, or an organic neutralization agent such as ethylene oxide, propylene oxide, ammonia, triethylamine, triethanolamine, and diethanolamine. Except for using a polymer solution prepared in this way, the same procedure as described above serves to form a porous support layer containing polyamide.

### (2-2) Formation of Separation Functional Layer

### Polycondensation of Polyamide

The process for forming the separation functional layer is described next. The separation functional layer is formed through an interfacial polycondensation reaction in which a polyfunctional amine and a polyfunctional acid halide are polymerized into a cross-linked polyamide on the porous support membrane.

More specifically, the separation functional layer is formed through the following steps:
(a) a step for applying an aqueous solution containing a polyfunctional amine on a porous support layer,
(b) a step carried out subsequent to the step (a) for applying an organic solvent solution containing a polyfunctional acid halide on the porous support layer, and
(c) a step carried out subsequent to the step (b) for removing the organic solvent solution.

In the step (a), the polyfunctional amine concentration in the aqueous polyfunctional amine solution is preferably in the range of 0.1 wt % or more and 20 wt % or less and more preferably in the range of 0.5 wt % or more and 15 wt % or less. If the polyfunctional amine concentration is in this range, a sufficient separation selectivity and gas permeability can be realized.

The aqueous polyfunctional amine solution may contain other components such as a surfactant, organic solvent, alkaline compound, and antioxidant unless they interfere with the reaction of the polyfunctional amine and the polyfunctional acid halide. A surfactant can act to improve the wettability of the surface of the support membrane and decrease the interface tension between the aqueous polyfunctional amine solution and the nonpolar solvent.

The application of the aqueous polyfunctional amine solution on the porous support layer is preferably performed uniformly and continuously on the porous support layer. The term “application” means bringing the aqueous polyfunctional amine solution into contact with the porous support layer, and more specifically, it refers to applying the aqueous polyfunctional amine solution to the surface of the porous support layer, immersing the support membrane in the aqueous polyfunctional amine solution, etc. Useful application methods include dropping, spraying, and roller coating.

The time elapsing after applying the aqueous polyfunctional amine solution on the porous support layer until removing liquid or until applying the polyfunctional acid halide (that is, the contact time between the porous support layer and the aqueous polyfunctional amine solution) is preferably 1 second or more and 10 minutes or less and more preferably 10 seconds or more and 3 minutes or less.

After applying the polyfunctional amine solution on the porous support layer, liquid is removed in such a manner that no drops of liquid are left on the porous support layer. If drops of liquid are left, they can cause defects on the membrane to reduce its separation performance, but removal of liquid works to prevent it. This can be achieved by, for example, suspending the support membrane coated with the aqueous polyfunctional amine solution in the vertical direction to allow the excess aqueous solution to fall freely or applying a flow of gas such as nitrogen from a nozzle etc. to remove liquid forcedly.

In the step (b), the concentration of the polyfunctional acid halide in the organic solvent solution is preferably in the range of 0.01 wt % or more and 10 wt % or less and more preferably in the range of 0.02 wt % or more and 2.0 wt % or less. A sufficient reaction speed can be realized if it is 0.01 wt % or more whereas the occurrence of side reactions can be prevented if it is 10 wt % or less.

The organic solvent to be used in the step (b) is preferably immiscible with water, dissolves the polyfunctional acid halide, and does not destroy the support membrane, and it is also preferably inactive to the polyfunctional amine compound and the polyfunctional acid halide. Preferred examples include hydrocarbon compounds such as n-hexane, n-octane, n-nonane, n-decane, n-undecane, n-dodecane, n-tridecane, isooctane, isodecane, and isododecane.

For the application of the polyfunctional acid halide solution on the porous support layer, those methods available for the application of the aqueous polyfunctional amine solution on the porous support layer may be used. However, since it is preferable for the polyfunctional acid halide solution to be applied to only one side of the porous support layer, the use of a coating technique is preferred to immersion.

In the step (c), the organic solvent solution left after the reaction is removed by an appropriate technique for removal of liquid. The technique to be used for removal of the organic solvent is not particularly limited, and examples thereof include suspending the membrane in the vertical direction to allow the excess aqueous organic solution to fall freely, blowing air from a blower against the membrane to remove the organic solvent, and using a fluid mixture of water and air (twin fluid) to remove the excess organic solvent.

For the aforementioned process for forming the separation functional layer, the amount of the polyfunctional amine X1 (mol/m²) held on the support membrane at the start of the step (b) and the amount of the polyfunctional amine X2 (mol/m²) held on the support membrane at the end of the step (c) satisfy the relation X2/X1≤0.5. Here, X1 is the amount of the polyfunctional amine held on the support membrane before the polycondensation reaction with the polyfunctional acid halide and X2 is the amount of the polyfunctional amine held on the support membrane after the polycondensation reaction. A smaller X2/X1 ratio means a higher consumption rate of the polyfunctional amine in the polycondensation reaction.

At a stage where the monomer consumption rate is small, many coarse pores are present in the thin layer of polyamide. As many monomers are consumed, however, a large amount of polyamide is produced accordingly and the thin layer of polyamide increases in thickness or density, thereby filing or decreasing the coarse pores. As a result, this allows the average and standard deviation of the deformation of the separation functional layer to be in the aforementioned preferable ranges.

In order to allow this production method to realize both high practicality and high membrane performance, it preferably satisfies the relation of X2/X1≤0.3, more preferably X2/X1≤0.25, and particularly preferably X2/X1≤0.2.

There are no particular limitations on the method to be used to measure the amount of the polyfunctional amine applied on the support membrane, but ultraviolet absorption spectroscopy (UV) analysis can be used for the determination thereof. According to the Lambert-Beer law, the ultraviolet visible absorption intensity, Abs., is proportional to the concentration of the chemical species that absorbs light. Accordingly, the ratio in the concentration of the polyfunctional amine can be determined from the ratio in the ultraviolet-visible absorption intensity. Specifically, at the start of the step (b) and the end of the step (c) carried out for a predetermined area, support membrane specimens having the same area (for example, 20 cm²) are taken and cut fine, and then they are immersed in the same amount of ethanol. The polyfunctional amine held on the support membrane is extracted with ethanol. The extracted ethanol solution is examined by UV analysis, and the ratio in the amount of the polyfunctional amine held on a unit area of the support membrane is calculated from the ratio in the absorption intensity attributed to the polyfunctional amine. The ethanol solution to be examined by UV analysis may be diluted as required.

To adjust the X1/X2 ratio in the aforementioned range, a good method is, for example, to provide an idle time between the end of the step (b) and the start of the step (c). The support membrane is preferably left to stand during the time. If the standing time is sufficiently long, the polycondensation reaction can be allowed to progress sufficiently. The standing time is preferably 30 seconds or more and more preferably 1 minute or more. The upper limit of the standing time is not particularly limited, but it is particularly preferably 1 day or less from the viewpoint of the practicality of the production method.

If the support membrane is left to stand between the end of the step (b) and the start of the step (c), the support membrane may be heated. The heating temperature is preferably 50° C. or more and 180° C. or less, more preferably 60° C. or more and 160° C. or less, still more preferably 80° C. or more and 160° C. or less, and particularly preferably 100° C. or more and 160° C. or less. If it is heated at 50° C. or more, the decrease in reaction speed caused by monomer consumption in the interfacial polymerization reaction can be made up by promoting the thermal reaction. If it is heated at 180° C. or less, it serves to prevent the reaction efficiency from decreasing considerably as a result of complete volatilization of the solvent. In addition, the temperature may change during the standing time.

The heat treatment time is preferably 5 seconds or more and 1 hour or less. A reaction promotion effect can be achieved if the heat treatment time is 5 seconds or more, whereas complete volatilization of the solvent can be prevented if the heat treatment time is 1 hour or less. Furthermore, the heat treatment time is preferably 30 seconds or more and more preferably 60 seconds or more.

Another method to adjust the X2/X1 ratio in the aforementioned range is to accelerate the interfacial polymerization reaction. There are no particular limitations on the method to be used to accelerate the interfacial polymerization reaction, but a reaction accelerator may be added to either the aqueous polyfunctional amine solution and the organic solvent solution containing a polyfunctional acid halide. There are no particular limitations on the reaction accelerator to be used, but some organic solvents can work as catalysts for interfacial polycondensation reactions, and accordingly, their addition to the aqueous polyfunctional amine solution may act to cause the interfacial polycondensation reaction to progress efficiently. In addition, the addition of an acylation catalyst such as DMF to the organic solvent solution may work to accelerate the interfacial polycondensation reaction.

In another method, vibrations may be given to the porous support layer that is in contact with the organic solvent solution containing a polyfunctional acid halide. Giving vibrations can serve to promote the diffusion of the polyfunctional amine held on the support membrane into the organic solvent solution. It is also a good method to add a polyfunctional halide at some point during the interfacial polycondensation reaction to promote the consumption of the polyfunctional amine.

### (2-3) Drying of Separation Membrane

The separation membrane formed in this way has to be dried. There are no particular limitations on the method to be used for drying, and good methods include vacuum drying, freeze drying, high temperature heating for water removal, immersion in ethanol, isopropanol, other alcohol solvents, or hydrocarbon solvents to replace water with these solvents, followed by removing the solvents under the aforementioned drying conditions.

In particular, high temperature heating is preferable because a dense separation functional layer can be produced by a simple procedure. There are no particular limitations on the method to be used for high temperature heating, but it is desirable to perform heating in an oven at 30° C. to 200° C., preferably 50° C. to 150° C., for 1 minute or more. Water can be efficiently removed if the temperature is 50° C. or more, whereas deformation attributable to a difference in heat shrinkage between the separation functional layer and the base substrate can be prevented if the temperature is 150° C. or less.

### 3. Gas Separation Membrane Element

### (3-1) Outline

As an example of the separation membrane element, a spiral type element is described below. FIG. 3 is a partly exploded oblique perspective view of a spiral type element 50. As illustrated in FIG. 3, the spiral type element 50 contains a central pipe 51, a gas separation membrane 52, a supply side flow channel material 53, a outgoing side flow channel material 54, the first end plate 55, and the second end plate 56.

### (3-2) Central Pipe

The central pipe 51 is a hollow tubular member having through-holes in the side face. From the viewpoint of pressure resistance and heat resistance, the central pipe 51 is preferably made of a metal such as SUS (Stainless Used Steel), aluminum, copper, brass, and titanium, but its material, shape, size, etc. are optional.

### (3-3) Separation Membrane

The separation membrane 52 is as described above. The separation membrane proposed herein not only has high separation selectivity for light gases, but also includes a separation functional layer having an average protrusion deformation of 5.0 nm or more to allow the thin layer to have a moderate flexibility, which leads to an increased physical structural stability against impacts caused by bending, folding, swinging, etc. and to an increased resistance to the generation of defective pinholes. In addition, since the standard deviation of the deformation is 5.0 nm or less, the thin layer has a uniform pore structure with a decreased number of coarse pores, leading to a decreased variation in the light gas separation selectivity of the membrane. Specifically, the membrane has a high physical structural stability against impacts caused by bending, folding, etc., which may be feared to occur during the production of a gas separation membrane element, and it is also high in physical structural stability against impacts caused by swinging etc. of the gas separation membrane element, which may be feared to occur during use of the gas separation membrane element. Thus, since the generation of pinhole defects during production and use can be controlled, the separation membrane according to the present invention element not only shows a high separation selectivity for light gases at the start of use but also maintains a high separation selectivity for light gases for a long term use.

The separation membrane 52 is interposed between the supply side flow channel material 53 and the outgoing side flow channel material 54, and winds spirally around the central pipe 51. A spiral type element may contain a plurality of separation membranes 52. Having these winding members, the spiral type element 50 has a roughly cylindrical appearance with a long axis in the length direction of the central pipe 51.

Separation membranes 52 are put one over another in such a manner that their separation functional layer side (supply side) surfaces face each other while their base substrate side (outgoing side) surfaces face each other.

The supply side flow channel material 53 is located on the separation functional layer side surface of the separation membrane 52 while the outgoing side flow channel material 54 is located on the base substrate side surface. In view of this, the surface that faces on the separation function layer side is referred as the supply side surface while the surface on the base substrate side is referred to as the outgoing side surface.

The supply side flow channel is open at both length-directional ends of the central pipe 51. Thus, a supply side inlet is provided at one end of the spiral type element 50 while a supply side outlet is provided at the other end. Compared with this, the supply side flow channel is sealed at the inner end of the winding direction, that is, at the central pipe side end. The sealing is carried out by folding of the separation membranes, adhesion between separation membranes with a hot-melt or chemical adhesive, or fusion bonding between separation membranes by laser etc.

### (3-4) Flow Channel Material

### Outline

The supply side flow channel material 53 and the outgoing side flow channel material 54 work as spacers to provide flow channels between separation membranes. The outgoing side flow channel material and the supply side flow channel material may be either the same member or different members. The outgoing side flow channel material and the supply side flow channel material are hereinafter referred to collectively as flow channel material.

Useful flow channel materials include a net, nonwoven fabric, tricot, other knit fabrics, film, and other porous sheets. They may be in the form of a sheet having projections of resin formed on either side or both sides thereof. As another method, projections may be fixed directly to the separation membranes to allow these projections to work as flow channel material.

In the case of a flow channel material that contains a sheet and projections, the projections may have a dot-like, curved, or linear shape. If it has a curved or linear shape, the gas flow can be controlled along the shape. At least, the projections should be made of components that will not suffer degradation under the relevant use conditions including pressure, temperature, and type of the supply side gas.

### Materials

It is preferable that the flow channel material is made of thermoplastic resin. From the viewpoint of preventing damage to the separation membranes, good examples of such thermoplastic resin include polyester, nylon, polyphenylene sulfide, polyethylene, polypropylene, polysulfone, polyethersulfone, polylactic acid, ABS (acrylonitrile-butadiene-styrene) resin, and UV-curable resins.

### Pore Diameter

The separation membranes may be damaged if used in elements mounted on pressure vessels or used under pressure in long term operation. At least either, preferably both, of the supply side flow channel material and the outgoing side flow channel material preferably have an average pore diameter of 1 mm or less because it serves to disperse the stress working on the separation membranes or reduce the likely damage. The average pore diameter is more preferably 0.4 mm or less and particularly preferably 0.1 mm or less. The average pore diameter is the average of equivalent circle diameters calculated as 4×pore area/pore circumference in plane of flow channel material. On either surface of a flow channel material, 30 pores are selected and their areas and circumferences are measured, followed by calculating the equivalent circle diameters. The average value R1 of the 30 equivalent circle diameters obtained in this way is calculated. For the other surface of the flow channel material, the average value R2 of equivalent circle diameters are calculated in the same way and the average of R1 and R2 is determined.

### (Thickness)

Here, at least either, preferably both, of the supply side flow channel material and the outgoing side flow channel material preferably has a thickness of 150 μm or less, more preferably 80 μm or less, and particularly preferably 50 μm or less. If the flow channel materials have such small thickness, they are small in bending rigidity and resistant to cracking. In addition, thin flow channel materials serve to allow the separation membranes to have increased areas while maintain the volume of the separation membrane element.

### (3-5) End Plate

The first end plate 55 and the second end plate 56 are disk-like members that are attached to the first end and the second end, respectively, i.e. extremities in the long axis direction, of the separation membrane roll. The first end is the upstream extremity of the gas flow, whereas the second end is the downstream extremity. The first end plate 55 has holes through which gas is supplied into the supply side flow channel. For connection in series to another spiral type element, the first end plate 55 have holes which allow gas to flow into the gas central pipe 51. The second end plate 56 has holes for the passage of gas discharged from the supply side flow channel and other holes for the passage of the permeating gas discharged from the central pipe 51. The spoke wheel-like end plates 55 and 56 shown in FIG. 4 are an example of such an end plate.

### 4. Gas Production Method

The separation membrane described above can be applied to a gas production method in which it allows light gases such as hydrogen and helium to pass selectively.

The gas production method according to this embodiment includes the steps described below:
(1) a step for supplying a mixed gas containing at least either hydrogen or helium, hereafter referred to as light gas A, and a gas other than the light gas A, hereafter referred to as gas B, to one face of the gas separation membrane, and
(2) a step for obtaining a gas having a larger gas A/gas B molar ratio than the original mixed gas from the other face of the gas separation membrane.

In this way, according to the present production method, a permeating gas having a decreased gas B concentration can be separated from a mixed gas of a light gas A and a gas B by means of a difference between the permeability of the separation membrane to the light gas A and that to the gas B, i.e. the unnecessary component.

There are no particular limitations on the type of the gas B, but it is preferable for the mixed gas to include at least one of, for example, carbon dioxide, oxygen, nitrogen, and methane, as the gas B. This is because it is the large difference between the permeability to hydrogen and helium and that to carbon dioxide, oxygen, nitrogen, and methane that allows the gas separation membrane to achieve efficient separation of hydrogen and helium.

In addition, the mixed gas may also contain water vapor. In general, water vapor tends to adhere to the membrane and acts to decrease the separation selectivity for light gases, but the aforementioned gas separation membrane shows a high separation selectivity for light gases even when water vapor is contained in the supply gas. In addition, the aforementioned gas separation membrane has a uniform pore structure and contains few coarse pores, and accordingly, it works efficiently for the removal of water vapor.

A spiral type gas separation membrane element as described above can be used for the gas production method according to the present invention. The gas production method according to the present invention, furthermore, may use pressure vessels connected in series and/or in parallel or may use a gas separation membrane module that consists of a pressure vessel as described above and a gas separation membrane element contained therein.

In the step (1), the supply gas may be compressed by a compressor before being sent to the gas separation membrane (or an element or module thereof) or the space on the outgoing side of the gas separation membrane may be depressurized by a pump.

It may also be good to use a plurality of elements or modules connected in series. When a plurality of elements or modules is used, a downstream module may receive either filtered gas from an upstream module or unfiltered gas. Furthermore, either filtered gas from a downstream module or unfiltered gas may be combined with the supply gas to an upstream module. When filtered gas or unfiltered gas is supplied to a downstream module, the filtered gas or the unfiltered gas to be supplied may be compressed by a compressor before being supplied.

There are no particular limitations on the supply pressure for the gas, but it is preferably 0.1 to 10 MPa. If it is 0.1 Mpa or more, an increased gas filtering rate is ensured, whereas if it is 10 Mpa or less, the gas separation membrane or the element or module thereof can be prevented from undergoing pressure deformation. There are no particular limitations as well on the ratio of the supply side pressure to the outgoing side pressure, but it is preferably 2 to 20. If the ratio of the supply side pressure to the outgoing side pressure is 2 or more, an increased gas filtering rate is ensured, whereas if it is 20 or less, the power cost for the supply side compressor or that for the outgoing side pump can be reduced.

The supply temperature of the gas is not particularly limited, but it is preferably 0° C. to 200° C. and more preferably 25° C. to 180° C. If it is 25° C. or more, a high gas filtering rate is ensured, whereas if it is 180° C. or less, the module members can be prevented from undergoing thermal deformation. If the above separation membrane is used, it is possible to supply gas at a temperature of 80° C. or more, 90° C. or more, or 100° C. or more.

The gas separation process in the spiral type element 50 is described below with reference to FIG. 4. A mixed gas G1 is fed from the first end of the spiral type element 50 into the supply side flow channel. After passing through the separation membrane 52, the filtered gas G2 moves through the outgoing side flow channel and flows into the central pipe 51. The filtered gas G2 is discharged from the second end of the spiral type element 50. The concentrated gas G3, which has avoided flowing into the separation membrane 52, is sent into the supply side flow channel and discharged from the second end of the spiral type element 50.

### EXAMPLES

The present invention will now be illustrated in more detail below with reference to examples, although the invention should not be construed as being limited to these examples.

### (1) Production of Separation Membrane

Operations are performed at room temperature (25° C.) unless otherwise specified.

### Preparation of Support Membrane

### Reference Example 1

A 16 wt % polysulfone (PSf) solution in DMF was cast at a temperature of 25° C. to a thickness of 200 μm on a polyester nonwoven fabric (air permeability 2.0 cc/cm²/sec), which was used as base substrate, immediately immersed in pure water, and left to stand for 5 minutes to form a porous support layer. In this way, a support membrane 1 that included a base substrate and a porous support layer was produced.

### Reference Example 2

In dehydrated N-methyl-2-pyrrolidone, 2-chloroparaphenylene diamine and 4,4′-diaminodiphenyl ether were dissolved in amounts corresponding to 80 mol % and 20 mol %, respectively, and 2-chloroterephthalic acid chloride was added in an amount corresponding to 100 mol %, followed by stirring for 2 hours to perform polymerization. Subsequently, neutralization was performed with lithium carbonate to provide an aromatic polyamide solution with a polymer concentration of 10 mass %, followed by diluting it to 6 wt %.

The resulting NMP solution was cast at a temperature of 25° C. to a thickness of 200 μm on a polyphenylene sulfide nonwoven fabric (air permeability 2.0 cc/cm²/sec), immediately immersed in pure water, and left to stand for 5 minutes to form a porous support layer. In this way, a support membrane 2 that included a base substrate and a porous support layer was produced.

### Formation of Separation Functional Layer

The support membrane prepared in Reference example 1 or 2 was immersed for 2 minutes in an aqueous m-phenylenediamine (m-PDA) solution having a concentration as specified in Table 1. The support membrane was pulled up slowly in the vertical direction, and nitrogen was blown from a nozzle against it to remove the excess aqueous solution from the surface of the porous support layer.

In addition, a trimesic acid chloride (TMC) solution having a constitution as specified in Table 1 was applied on the surface of the porous support layer in such a manner that it was completely wetted, and it was left to stand under conditions as specified in Table 1 to form a separation functional layer through an interfacial polymerization reaction. In Comparative example 1, however, m-PDA having a 1% weight of TMC was added to the TMC solution 3 minutes before it was applied.

Then, the membrane was suspended in the vertical direction to allow the solution to fall to remove the excess solution from the membrane, and air at 20° C. was blown from a blower against it to dry it for complete removal of liquid.

Finally, the membrane was rinsed with pure water at a temperature specified in Table 1 for 10 hours and then air-dried at 25° C. to provide a gas separation membrane.

Table 1 also shows the conditions for interfacial polymerization adopted in each Example and Comparative example.

### Determination of the Amount of Polyfunctional Amine Held on Support Membrane

A 20 cm² membrane specimen was cut out of the support membrane used in each Example and Comparative example. This support membrane specimen was immersed in an aqueous m-PDA solution, followed by removal of liquid, under the conditions specified for each Example and Comparative example. The resulting porous support layer was cut into 1 cm² square pieces and they were immersed in 20 g of ethanol and left to stand for 8 hours or more. The extraction liquid was diluted about 20 times and examined using an ultraviolet-visible spectrophotometer (UV-2450, manufactured by Shimadzu Corporation) to measure its ultraviolet-visible absorption spectrum, in which the maximum absorption intensity (Abs) at 294.5 nm attributed to m-phenylene diamine was determined and designated as X1.

In addition, the porous support layer immersed in an aqueous m-PDA solution, followed by removal of liquid, by the procedure specified for each Example and Comparative example was then brought into contact with a TMC solution under the respective conditions, followed by removal of liquid.

The support layer was also examined by the procedure described above to measure its ultraviolet-visible absorption spectrum, and the maximum absorption intensity attributed to polyfunctional amine was determined and designated as X2.

Here, the X2/X1 ratio was calculated by dividing the value of X2 by the value of X1 obtained above.

TABLE 1

| | | | | | | standing | | |
|---|---|---|---|---|---|---|---|---|
| | support | aqueous m- | | | | conditions | | |
| | membrane | PDA solution | TMC solution | | | (interfacial | rinsing | |
| | (Reference | concentration | concentration | | | polymerization | temperature | |
| | example) | wt % | wt % | additive | solvent | conditions) | (° C.) | X2/X1 |
| Example 1 | 2 | 6 | 0.16 | — | undecane | 30 sec at | 50 | 0.16 |
| | | | | | | 25° C.,then | | |
| | | | | | | 270 sec at | | |
| | | | | | | 100° C. | | |
| Example 2 | 2 | 6 | 0.16 | — | decane | 30 sec at | 50 | 0.5 |
| | | | | | | 25° C.,then 60 | | |
| | | | | | | sec at 100° C. | | |
| Example 3 | 1 | 6 | 0.16 | — | isooctane | 300 sec at | 50 | 0.1 |
| | | | | | | 25° C. | | |
| Example 4 | 2 | 6 | 0.16 | — | undecane | 30 sec at | 50 | 0.05 |
| | | | | | | 25° C.,then | | |
| | | | | | | 570 sec at | | |
| | | | | | | 130° C. | | |
| Comparative | 1 | 4 | 0.12 | m-PDA | isooctane | 30 sec at | 90 | 0.93 |
| example 1 | | | | | | 25° C. | | |
| Comparative | 1 | 4 | 0.12 | — | isooctane | 60 sec at | 90 | 0.88 |
| example 2 | | | | | | 80° C. | | |
| Comparative | 2 | 6 | 0.16 | — | dodecane | 30 sec at | 50 | 0.81 |
| example 3 | | | | | | 25° C.,then 45 | | |
| | | | | | | sec at 80° C. | | |

The X2/X1 ratio decreased as the standing time, i.e. the polymerization time, was prolonged. This means that monomers were consumed in a larger amount. In particular, the X2/X1 ratio decreased to 0.50 or less when heating was performed at 100° C. or more for 60 seconds or more in the standing (polycondensation) step or the step was continued for 300 seconds or more.

### Deformation of Protrusions

A separation membrane in a dry state was cut to prepare a 1 cm square sample and it was fixed to a sample table with an adhesive in such a manner that the separation functional layer faced upward. Then, the sample table was fixed to a measuring stage using a magnet and pure water was dropped on the separation functional layer, followed by surface observation by atomic force microscopy (AFM). From the images taken, 20 force curves of protrusions were extracted and their deformations were analyzed to calculate their average and standard deviation. More specifically, the measuring conditions used were as described below.
Equipment: Dimension FastScan, manufactured by Bruker AXS
Scanning mode: underwater nanomechanical mapping
Probing: silicon cantilever (ScanAsyst-Fluid, manufactured by Bruker AXS) The cantilever was calibrated before use for measurement.
Maximum load: 3.0 nN
Scanning range: 5 μm×5 μm
Scanning speed: 0.5 Hz
Number of pixels: 256×256
Measuring conditions: in pure water
Measuring temperature: 25° C.

### Evaluation of Separation Performance for H₂/N₂ Mixed Humidified Gas

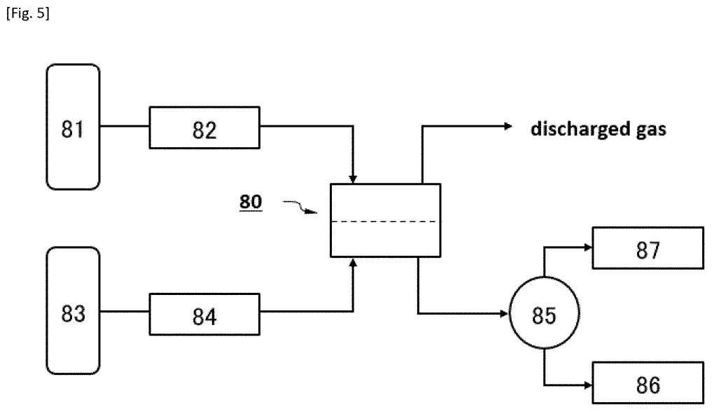

An apparatus as illustrated in FIG. 5 was used to measure the gas permeabilities of separation membranes according to JIS K 7126-2B (2006). A test cell 80 having a supply side cell and an outgoing side cell was prepared and a separation membrane was set between the supply side cell and the outgoing side cell. The flow rate of gas supplied from the gas cylinder 81 to the supply side cell was controlled by the mass flow controller 82. In addition, argon, which was adopted as sweep gas, was supplied from the gas cylinder 83 to the outgoing side cell. The flow rate of the sweep gas was controlled by the mass flow controller 84. Here, the supply gas was humidified to 95% RH by a humidifier that is not shown in the figure.
Effective film area of separation membrane: 25 cm²
Cell temperature: 25° C.
Supply gas: a mixed gas of hydrogen and nitrogen (volume ratio 1:1), 1 atm, flow rate 100 cm³/min
Sweep gas: argon, 100 cm³/min, 1 atm

Forty minutes after the start of gas supply, the flow was switched by the valve 85 to send a mixture of the filtered gas and the sweep gas to the gas chromatograph 86, which was equipped with a TCD (thermal conductivity detector). Then, the concentrations of hydrogen and nitrogen in the mixture were analyzed. The valve 85 also worked to switch the flow direction of the mixture of the filtered gas and the sweep gas to the soap-film flow meter 86, where the flow rate was measured.

From these measured flow rate and concentration, the permeabilities to hydrogen, nitrogen, and water vapor were calculated. Then, the separation selectivity was calculated by dividing the hydrogen permeability by the nitrogen permeability obtained above. The calculation was rounded off to a whole number.

### Evaluation of Membrane Water Permeation Flux

For the membranes prepared in Comparative examples and Examples, an aqueous sodium chloride solution (concentration 3.5 wt %) adjusted to a temperature of 25° C. and a pH of 6.5 was supplied under an operating pressure of 5.5 MPa to perform a compressed flow test for 24 hours. From the weight of filtered liquid, the membrane water permeation flux (m³/m²/day) was calculated in terms of the volume (m³) of filtered liquid per day per square meter of the membrane.

TABLE 2

| | deformation of protrusions | | | | | separation | membrane |
|---|---|---|---|---|---|---|---|
| | (nm) | | permeability | | | selectivity | water |
| | | standard | (nmol/m²/s/Pa) | | | (−) | permeation flux |
| | average | deviation | H₂ | N₂ | water vapor | H₂/N₂ | (m³/m²/day) |
| Example 1 | 10 | 4.4 | 2.1 | 0.1 | 165 | 21 | 0.23 |
| Example 2 | 9.1 | 2.9 | 3 | 0.1 | 150 | 30 | 0.28 |
| Example 3 | 5.9 | 3.9 | 7.1 | 0.3 | 165 | 24 | 0.50 |
| Example 4 | 5.1 | 2.2 | 2.2 | <0.1 | 125 | 59 | 0.16 |
| Comparative | 3.6 | 1.1 | 53.2 | 11.9 | 350 | 4 | 1.10 |
| example 1 | | | | | | | |
| Comparative | 8.4 | 5.2 | 25.2 | 4.5 | 200 | 6 | 0.80 |
| example 2 | | | | | | | |
| Comparative | 11.7 | 5.1 | 6.2 | 1 | 195 | 6 | 0.55 |
| example 3 | | | | | | | |

It is clearly seen from the results given in Table 2 that when protrusions were indented under a maximum load of 3.0 nN, the separation membrane prepared in each of Examples 1 to 4 showed an average deformation of 5.0 nm or more and 10.0 nm or less and a standard deviation of 5.0 nm or less, proving that it was higher in H₂/N₂ separation selectivity and He/O₂ separation selectivity than in Comparative examples 1 to 3 where such good results were not obtained. In particular, the separation membranes prepared in Examples 2 and 3, both showing a standard deviation of the deformation of 4.0 nm or less, were higher in H₂/N₂ separation selectivity and He/O₂ separation selectivity than in Example 1. In addition, the separation membrane described in Example 4, which showed a standard deviation of the deformation of less than 2.5 nm, had an H₂/N₂ separation selectivity and He/O₂ separation selectivity of as high as 59. Furthermore, the membranes prepared in Examples 1 to 4 were lower in water vapor permeability than those in Comparative examples 1 to 3, indicating that they were better in terms of removal of water vapor. For all membranes in Examples 1 to 4, the membrane water permeation flux was not more than 0.5 (m³/m²/day).

### Evaluation of Pure Gas Permeation Performance

Except for using hydrogen, carbon dioxide, nitrogen, or methane as supply gas, the same procedure as for the evaluation of separation performance for humidified gas was carried out to determine the gas permeability. Humidifying treatment was omitted.

TABLE 3

| | pure gas permeability | | | | | | |
|---|---|---|---|---|---|---|---|
| | (nmol/m²/s/Pa) | | | | selectivity (−) | | |
| | H₂ | CO₂ | N₂ | CH₄ | H₂/CO₂ | H₂/N₂ | H₂/CH₄ |
| Example 1 | 8.5 | 0.7 | 0.3 | 0.3 | 12 | 33 | 27 |
| Example 4 | 7.4 | 0.3 | 0.1 | 0.1 | 26 | 68 | 79 |
| Comparative | 46 | 5.9 | 5.8 | 4.5 | 8 | 8 | 6 |
| example 1 | | | | | | | |

It is clearly seen from the results given in Table 3 that when protrusions were indented under a load of 3.0 nN, the separation membranes that showed an average deformation of 5.0 nm or more and 10.0 nm or less and a standard deviation of 5.0 nm or less had high separation selectivity in separating light gases such as hydrogen and helium from other gases such as carbon dioxide, nitrogen, and methane in the evaluation of pure gas permeation performance.

### INDUSTRIAL APPLICABILITY

The gas separation membrane element according to the present invention can be used suitably for separating and purifying a specific gas from a mixed gas.

### EXPLANATION OF NUMERALS

50: spiral type element
51: central pipe
52: gas separation membrane
53: supply side flow channel material
54: outgoing side flow channel material
55: first end plate
56: second end plate
G1: mixed gas
G2: filtered gas
G3: concentrated gas
73: separation functional layer
74: porous support layer
75: base substrate
81: raw gas material cylinder
82: raw gas material mass flow controller
83: sweep gas cylinder
84: sweep gas mass flow controller
80: permeation cell equipped with separation membrane
85: valve
86: gas chromatography
87: soap-film flow meter

1. A gas separation membrane comprising a support membrane having a base substrate and a porous support layer laid on the base substrate, and a separation functional layer laid on the porous support layer, wherein:
the separation functional layer is a thin layer having a protuberance structure containing a plurality of protrusions and recesses;
20 of the protrusions give an average deformation of 5.0 nm or more and 10.0 nm or less when indented under a maximum load of 3 nN in pure water at 25° C.; and
they give a standard deviation of the deformation of 5.0 nm or less.

2. A gas separation membrane as set forth in claim 1, wherein the standard deviation of the deformation is 4.0 nm or less.

3. A gas separation membrane as set forth in claim 1, wherein the standard deviation of the deformation is 2.5 nm or less.

4. A gas separation membrane as set forth claim 1, wherein the porous support layer includes at least either polyamide or polyethersulfone.

5. A gas separation membrane as set forth in claim 1, wherein the membrane water permeation flux (m³/m²/day) is 0.5 (m³/m²/day) or less as determined from a water permeability test in which an aqueous sodium chloride solution having a concentration of 3.5 wt % and adjusted to a temperature of 25° C. and a pH of 6.5 is suppled under an operating pressure of 5.5 MPa.

6. A production method for a gas separation membrane as set forth in claim 1 comprising:
a step for forming a separation functional layer on a porous support layer,
the step comprising
(a) a step for applying an aqueous solution containing a polyfunctional amine on the porous support layer,
(b) a step for applying an organic solvent solution containing a polyfunctional acid halide on the porous support layer that is in contact with an aqueous solution containing a polyfunctional amine, and
(c) a step for removing the organic solvent solution, and
the amount of the polyfunctional amine held on the support membrane at the start of the step (b), designated as X1 (mol/m²), and the amount of the polyfunctional amine held on the support membrane at the end of the step (c), designated as X2 (mol/m²), satisfying the relation X2/X1≤0.5.

7. A gas separation membrane element comprising:
a central pipe for collecting filtered gas, and
a gas separation membrane as set forth in claim 1 that is wound spirally around the central pipe.

8. A gas production method using a gas separation membrane as set forth in claim 1 comprising:
(1) a step for supplying a mixed gas containing at least either hydrogen or helium, designated as light gas A, and a gas other than the light gas A, designated as gas B, to one face of the gas separation membrane, and
(2) a step for obtaining a gas having a larger gas A/gas B molar ratio than the mixed gas from the other face of the gas separation membrane.

9. A gas production method as set forth in claim 8, wherein the mixed gas includes at least one of carbon dioxide, oxygen, nitrogen, and methane, as the gas B.

10. A gas production method as set forth in either claim 8, wherein the mixed gas contains water vapor.
